(19) United States
(12) Patent Application Publication
(10) Pub. No.: US 2026/0202274 A1
(43) Pub. Date: Jul. 16, 2026

(54) TORQUE ANGLE SENSOR AND ELECTRIC POWER STEERING INCLUDING THE SAME

(71) Applicant: HL KLEMOVE CORP., Incheon (KR)

(72) Inventors: Jinseok BAE, Incheon (KR); Minha LEE, Incheon (KR)

(21) Appl. No.: 19/277,302

(22) Filed: Jul. 22, 2025

(30) Foreign Application Priority Data
Jan. 16, 2025 (KR) 10-2025-0006975

(51) Int. Cl. G01L 5/22; B62D 5/04

(52) U.S. Cl. CPC G01L 5/221; B62D 5/0481

(57) ABSTRACT

A torque angle sensor or an electric power steering including the same include a housing having a through hole through which a shaft passes, a gear assembly fixed to the shaft and rotating together with the shaft, a rotor coupled to the gear assembly and rotating together with the gear assembly, a printed circuit board mounted to the housing and detecting rotation of the rotor and torque applied to the shaft, and a spring member provided outside the housing and in a slot formed on an inner surface of a main housing accommodating the housing, wherein the spring member includes a support portion connected to one side of the housing, a connecting portion extending to be bent from a lower end of the support portion, and an elastic arm extending upward from the connecting portion and configured to be deformable in a width direction of the slot.

### CROSS-REFERENCE TO RELATED APPLICATION

This application claims the priority to Korean Patent Application No. 10-2025-0006975 filed on Jan. 16, 2025, in the Korean Intellectual Property Office, the disclosure of which is incorporated herein by reference in its entirety.

### BACKGROUND

### Field

The present disclosure generally relates to a torque angle sensor and an electric power steering including the same, and more specifically, to a torque angle sensor configured to detect a torque and a rotation angle according to rotation of a steering shaft, and an electric power steering including the same.

### Description of the Related Art

In general, a vehicle is equipped with an auxiliary steering device as a means to secure steering stability by reducing a steering force of a steering wheel. The auxiliary steering device provides an auxiliary operating force to enable smooth steering of the steering wheel and support a driver when a frictional resistance applied to the wheels of the vehicle is large and an operating force for steering the steering wheel is large.

In the related art, hydraulic power steering (HPS) has been widely used as an auxiliary steering device, but recently, an electric power steering (EPS) that assists steering using a motor has been widely applied. The EPS may have the advantage of low power loss and excellent accuracy.

The EPS provides optimal steering conditions to the driver by ensuring turning stability and providing rapid restoring force by driving a motor in an electronic control unit (ECU) according to driving conditions of a vehicle detected by a speed sensor, torque angle sensor, angle sensor, or the like.

A torque angle sensor (TAS) may integrate the functions of a torque sensor and an angle sensor among sensors included in a vehicle to detect information about the torque applied to the steering shaft and the rotation angle of the steering shaft by a single device.

However, the conventional torque angle sensor may have the problem in that a size of a printed circuit board (PCB) increases, thereby increasing the size of the product, or the combination or connection structure between component elements becomes complex and multi-layered.

### SUMMARY

According to some embodiments of the present disclosure, a torque angle sensor and an electric power steering including the same may enable simplification of a manufacturing process and reduction of cost through improvement in an output-side rotor installed on an output-side shaft of a steering shaft.

In addition, certain embodiments of the present disclosure may provide a structure capable of fixing a printed circuit board to a housing of a torque angle sensor in a more improved manner than conventional methods. More specifically, according to some embodiments of the present disclosure, a torque angle sensor and an electric power steering including the same may improve a fixing strength between a printed circuit board and a housing, and enable product miniaturization and reduction of manufacturing cost by eliminating a protruding structure of the printed circuit board.

Furthermore, certain embodiments of the present disclosure may simplify a structure and an assembly process of a torque angle sensor and increase robustness of an anti-rotation structure by eliminating an existing metal spring included in conventional art and replacing it with a single plastic material for implementing the anti-rotation structure of the torque angle sensor installed inside a main housing of the electric power steering.

According to one aspect of the present disclosure, there may be provided a torque angle sensor including: a housing having a through hole through which a steering shaft passes; a gear assembly accommodated inside the housing and fixed to the steering shaft and rotating together with the steering shaft; a rotor accommodated inside the housing and coupled to the gear assembly and rotating together with the gear assembly; a printed circuit board mounted on the housing and detecting rotation of the rotor and detecting torque applied to the steering shaft; and a spring member provided outside the housing and inserted into a slot formed on an inner surface of a main housing in which the housing is accommodated, in which the spring member includes a support portion connected to one side of the housing, a connecting portion extending to be bent from a lower end of the support portion, and an elastic arm extending upward from the connecting portion and deformable in a width direction of the slot.

The spring member may be made of plastic material.

The support portion, the connecting portion, and the elastic arm may be integrally provided.

The spring member may be integrally provided with the housing.

The connecting portion and the elastic arm may be indirectly connected via the support portion.

The elastic arm may be formed at a distance from the support portion in a direction along an outer wall surface of the housing in which the spring member is installed.

The elastic arm may be formed to be inclined at a predetermined angle have elasticity.

The elastic arm may have a thickness of less than 1.8 mm.

A maximum width of the spring member may be formed 10 to 20% larger than a width of the slot.

The spring member may further include a reinforcing rib formed on at least one of the inner and outer surfaces of the spring member to reinforce elasticity and rigidity of the spring member.

The reinforcing rib may have a predetermined thickness and height and a protruding shape, and may be formed to extend from a predetermined point on the support portion to a predetermined point on the elastic arm through the connecting portion.

The spring member may further include a stopper that extends from a side end of the support portion in a direction toward the elastic arm and comes into contact with a side wall of the slot instead of the elastic arm when the elastic arm is damaged.

The stopper may be provided as a plate-shaped member having a predetermined area and may be formed in a direction parallel to an outer wall surface of the housing where the spring member is installed.

The reinforcing rib and the stopper may be formed integrally with the spring member.

The spring member may be integrally formed with the housing.

The spring member may further include a reinforcing plate that is a structure interconnecting an inner wall surface of the support portion and an inner wall surface of the elastic arm and having a wave-shaped cross-section, and reinforces elasticity and rigidity of the spring member.

According to another aspect of the present disclosure, there may be provided an electric power steering including: a torque angle sensor including a housing having a through hole through which a steering shaft passes, a gear assembly accommodated inside the housing and fixed to the steering shaft and rotating together with the steering shaft, a rotor accommodated inside the housing and coupled to the gear assembly and rotating together with the gear assembly, a printed circuit board mounted on the housing and detecting rotation of the rotor and detecting torque applied to the steering shaft, and a spring member provided outside the housing; and a main housing in which the torque angle sensor is accommodated inside and which is fixedly installed on a vehicle body, in which the spring member is inserted into and coupled to a slot formed on an inner surface of a main housing, and the spring member includes a support portion connected to one side of the housing, a connecting portion extending to be bent from a lower end of the support portion, and an elastic arm extending upward from the connecting portion and deformable in a width direction of the slot.

The spring member may further include a reinforcing rib formed on at least one of the inner and outer surfaces of the spring member to reinforce elasticity and rigidity of the spring member.

The spring member may further include a stopper that extends from a side end of the support portion in a direction toward the elastic arm and comes into contact with a side wall of the slot instead of the elastic arm when the elastic arm is damaged.

The spring member may be made of plastic material and formed integrally with the housing when the housing is formed

The spring member may not include a separate metal spring.

The torque angle sensor according to certain embodiments of the present may simplify the manufacturing process and reduce the manufacturing cost by improving the output-side rotor installed on the output-side shaft of the steering shaft.

In addition, in the torque angle sensor according to some embodiments the present disclosure, the printed circuit board may be fixed to the housing using the hook fastening structure. Therefore, the fixing strength between the printed circuit board and the housing may be improved, and the structure protruding from the printed circuit board can be eliminated, thereby enabling product miniaturization and reduction in manufacturing costs.

In addition, according to some embodiments of the present disclosure, the anti-rotation structure of the torque angle sensor that is installed inside the main housing of the electric power steering may simplify the structure and the assembly process of torque angle sensor, reduce the manufacturing costs, and increase robustness of the anti-rotation structure by replacing an existing metal spring included in conventional art with a single plastic material.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic diagram of an electric power steering applied to a vehicle according to an embodiment of the present disclosure;

FIG. 2 is an exploded perspective view of a torque angle sensor according to an embodiment of the present disclosure;

FIG. 3 is a view illustrating an input-side rotor mounted on a torque angle sensor according to an embodiment of the present disclosure;

FIG. 4 is a view illustrating an output-side rotor of a conventional torque sensor;

FIG. 5 is a view illustrating an output-side rotor of a torque angle sensor according to an embodiment of the present disclosure;

FIG. 6 is a cross-sectional view taken along a line A-A′ in FIG. 5;

FIG. 7 is an enlarged view illustrating a portion of FIG. 5 where a second coupler is formed in an output-side rotor according to an embodiment of the present disclosure;

FIG. 8 is an enlarged view illustrating another portion of FIG. 5 formed on an inner surface of an output-side rotor according to an embodiment of the present disclosure;

FIGS. 9A and 9B are perspective and side views illustrating an output-side rotor, respectively, according to an embodiment of the present disclosure, FIG. 9A illustrates a perspective view of an output-side rotor before a separation prevention strap is bent, and FIG. 9B illustrates a perspective view of an output-side rotor after the separation prevention strap is bent;

FIGS. 10A and 10B are perspective and side views illustrating an output-side rotor, respectively, according to another embodiment of the present disclosure;

FIG. 11 is a view illustrating a state in which a printed circuit board is coupled to a housing of a torque angle sensor according to an embodiment of the present disclosure;

FIG. 12 is an enlarged view illustrating a part indicated by “B” in FIG. 11;

FIG. 13 is a view illustrating an anti-rotation structure provided in a housing of a torque angle sensor according to an embodiment of the present disclosure; and

FIG. 14 is a perspective view illustrating an anti-rotation structure according to another embodiment of the present disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Hereinafter, embodiments of the present disclosure will be described in detail with reference to the accompanying drawings. The following embodiments are presented to sufficiently convey the idea of the present disclosure to those skilled in the art to which the present disclosure pertains. The present disclosure is not limited to the embodiments presented herein and may be embodied in other forms. In order to clarify the present disclosure, the drawings may omit parts that are not related to the description, and may somewhat exaggerate the sizes of components to help understanding.

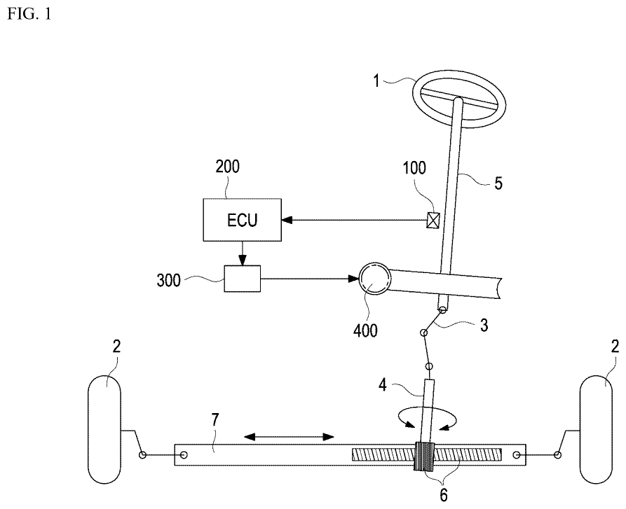

FIG. 1 is a schematic diagram of an electric power steering applied to a vehicle according to an embodiment of the present disclosure. Referring to FIG. 1, the vehicle includes a steering wheel 1 that can be operated or rotated by a driver and wheels 2 that contact the ground and move or steer the vehicle. A steering shaft 5 may have one side of which is connected to the steering wheel 1 and the other side of which is connected to a pinion shaft 4 via a pair of universal joints 3. The pinion shaft 4 is operably connected to a rack bar 7 via a rack-pinion mechanism 6, and the rack bar 7 is operably connected to the wheels 2 of the vehicle via a connection mechanism such as a tie rod and a knuckle arm.

In addition, the vehicle may have an electric power steering (EPS) system configured to assist steering. The EPS according to certain embodiments of the present disclosure may include a torque angle sensor 100, an electronic control unit 200, a motor 300, and a reducer 400. The torque angle sensor 100 may detect torque applied to the steering shaft 5 and/or a rotation angle of the steering shaft 5 and output the torque and/or rotation angle as electric signals. The electronic control unit 200 may generate a control signal based on the electric signals output from the torque angle sensor 100. For example, the electronic control unit 200 may include memory and/or one or more processors configured to control various electronic components included in the vehicle. The motor 300 may generate auxiliary power based on the output signal of the electronic control unit 200. The reducer 400 may be configured to reduce the power of the motor 300 and transmit the reduced power to the steering shaft 5.

The EPS system according to some embodiments of the present disclosure may be configured to detect both the torque applied to the steering shaft 5 and the rotation angle of the steering shaft 5 through the torque angle sensor 100 by integrating the functions of the torque sensor and the angle sensor into a single device.

The torque angle sensor 100 according to certain embodiments of the present disclosure may be coupled on, mounted around, or disposed adjacent to the steering shaft 5. More specifically, the torque angle sensor 100 according to some embodiments of the present disclosure may be coupled between an input-side shaft 5a and an output-side shaft 5b of the steering shaft 5. The steering shaft 5 may include the input-side shaft 5a connected to the steering wheel 1 and the output-side shaft 5b connected to the wheel 2. The rotation of the input-side shaft 5a may be transmitted to the output-side shaft 5b via a torsion bar of which both ends are fixedly coupled to or installed on the input-side shaft 5a and the output-side shaft 5b.

Below, examples of the structure and detailed configuration of the torque angle sensor 100 according to some exemplary embodiments of the present disclosure will be described in more detail.

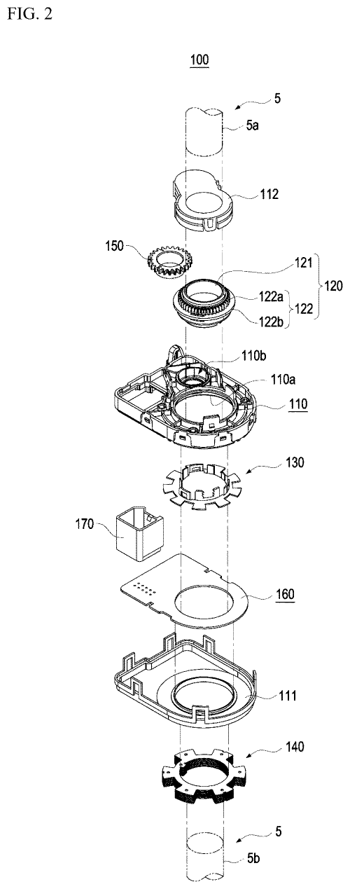

FIG. 2 is an exploded perspective view of a torque angle sensor according to an embodiment of the present disclosure. Referring to FIG. 2, the torque angle sensor 100 according to an embodiment of the present disclosure may include a housing 110, a gear assembly 120, an input-side rotor 130, an output-side rotor 140, an angle gear 150, and a printed circuit board 160.

The housing 110 may be made of a wear-resistant material such as a resin material, and has an inner space therein to accommodate components including one or more of the gear assembly 120, the input-side rotor 130, the angle gear 150, and the printed circuit board 160.

The housing (or an upper part of the housing) 110 may be coupled with a separate cover (or a lower part of the housing) 111 to form a case for the product. The cover 111 may serve to cover and protect components accommodated inside the housing 110. Alternatively, the cover 111 may be a part of the housing 110.

The housing 110 may include a circular through hole 110a and a circular gear groove 110b. The steering shaft 5 passes through the circular through hole 110a of the housing 110, and the gear assembly 120 is coupled to or disposed in the circular through hole 110a of the housing 110. The circular gear groove 110b accommodates the angle gear 150.

A catch for being coupled with a gear assembly 120 may be formed on the inner peripheral surface of the through hole 110a formed in the housing 110. The structure in which the gear assembly 120 is coupled to the through hole 110a of the housing 110 will be described in more detail later.

The angle gear 150 is rotatably accommodated in the gear groove 110b formed in the housing 110 or on one surface of the housing 110. In addition, a gear cover 112 may be coupled to the upper side of the housing 110. The gear cover 112 may cover and protect gear components or devices such as the gear assembly 120 and the angle gear 150 described below.

The printed circuit board 160 on which various electronic components for detecting the torque and rotation angle of the steering shaft 5 through the rotation of the rotors 130 and 140 are installed may be mounted on or disposed below the lower side of the housing 110.

The gear assembly 120 may include a cylindrical sleeve 121 and a gear mold 122. The cylindrical sleeve 121 may be fixed to the steering shaft 5 so as to rotate along with the steering shaft 5. The gear mold 122 may be coupled to or formed on the outside of the sleeve 121.

The sleeve 121 is a metal processing part and may be made of metal although not required, may be firmly coupled to the input-side shaft 5a of the steering shaft 5 through various methods such as caulking, press-fitting, and welding, and rotates together with the rotation of the steering shaft 5.

The gear mold 122 is a gear for transmitting an angle or torque to the angle gear 150 described later, and may be supported by and coupled to the outer peripheral surface of the sleeve 121. The gear mold 122 may be rotatably coupled to the through hole 110a of the housing 110, and is fixedly coupled to the input-side rotor 130 to rotate together.

The gear mold 122 may include a gear portion 122a and a holder portion 122b. The gear portion 122a is rotatably engaged with and is gear-coupled to the angle gear 150. The holder portion 122b may be formed below the gear portion 122a and may be rotatably coupled to the through hole 110a of the housing 110.

The gear portion 122a of the gear mold 122 may be provided as a gear having an overall ring shape with gear teeth formed on the outer peripheral surface of the gear. The gear teeth formed on the gear portion 122a may be rotatably connected to the gear teeth formed on the outer periphery of the angle gear 150.

At least one fastening ring may be formed on the outer peripheral surface of the holder portion 122b of the gear mold 122 so as to be rotatably coupled to the catch formed in the through hole 110a of the housing 110. As the catch formed in the through hole 110a of the housing 110 is hook-coupled to the fastening ring of the holder portion 122b, the catch may freely rotate in a circumferential direction on the fastening ring while separation between the housing 110 and the gear mold 122 is prevented along the axial direction of the steering shaft 5, and thus, the gear mold 122 may be rotatably coupled on the through hole 110a of the housing 110.

The gear mold 122 is coupled with the input-side rotor 130. For instance, the gear mold 122 may include hooks formed at regular intervals in the circumferential direction on the holder portion 122b and support ribs protruding from the inner peripheral surface of the holder portion 122b. The hooks and support ribs of the gear mold 122 may be injection-molded integrally with the holder portion 122b.

The gear mold 122 may be fixed to the input-side rotor 130 in the axial and rotational directions using hooks and support ribs of the gear mold 122, and the coupling structure between the gear mold 122 and the input-side rotor 130 will be described in more detail later.

The gear portion 122a and the holder portion 122b of the gear mold 122 may be formed integrally and coupled with and supported by the outer peripheral surface of the sleeve 121. In addition, the sleeve 121 and the gear mold 122 may also be manufactured as an integral part through insert molding or the like. That is, the gear assembly 120 according to an embodiment of the present disclosure may be provided with an integral configuration.

Therefore, when the steering operation is performed, the entire gear assembly 120 and the input-side rotor 130 rotate together. That is, when the steering shaft 5 rotates, the gear assembly 120 and the input-side rotor 130 rotate together, and this rotation means relative rotation with respect to the housing 110.

The input-side rotor 130 may be made of metal and be configured to transmit a torque signal to the printed circuit board 160. The input-side rotor 130 is coupled with the gear assembly 120 and is rotatable together with the gear assembly 120, and may be installed to rotate relatively freely with respect to the housing 110.

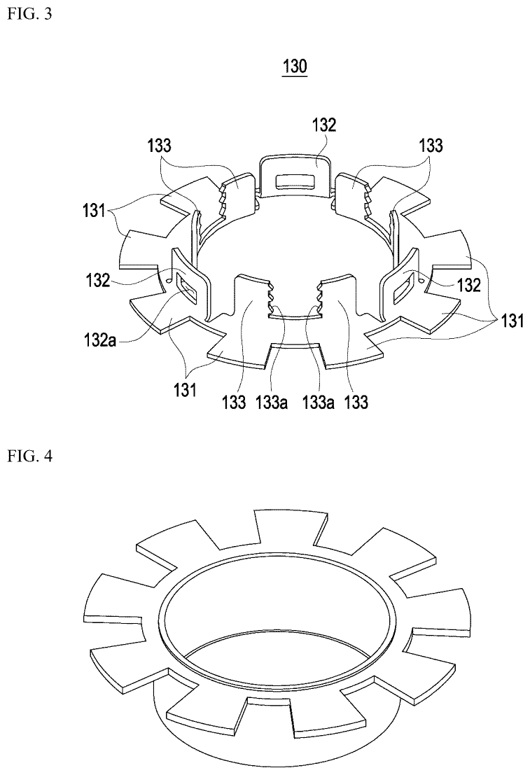

FIG. 3 is a view illustrating an input-side rotor according to an embodiment of the present disclosure. Referring to FIG. 3, the input-side rotor 130 may be provided as a hollow annular structure through which the steering shaft 5 can be inserted.

A first coupler 131 may be formed on the outer periphery of the input-side rotor 130. The first coupler 131 may be made of metal material, have a wing shape, be arranged along the circumference direction, and protrude from the outer periphery of the input-side rotor 130.

In addition, the input-side rotor 130 may include at least one fastening member or fastener for coupling the input-side rotor 130 with the gear mold 122. The fastening member or fastener may include a hook rib 132 and/or a press-fit rib 133. The hook rib 132 may be formed in the holder portion 122b of the gear mold 122 to be hooked and coupled. The press-fit rib 133 is configured to be press-fitted and coupled to both sides of a support rib formed in the holder portion 122b of the gear mold 122.

The hook rib 132 may protrude from one side of the input-side rotor 130 along the axial direction of the steering shaft 5 (in FIG. 3 of the exemplary embodiment, the hook rib 132 may be formed to extend upward) and may include a hook groove or hole 132a which penetrates or is recessed in the radial direction so that a hook of the gear mold 122 can be inserted and engaged in the hook groove or hole 132a.

The tip of the hook formed in the gear mold 122 is inserted into and hook-coupled to the hook groove 132a of the hook rib 132 formed in the input-side rotor 130, so that the gear mold 122 and the input-side rotor 130 may be firmly fixed in the axial direction.

In addition, the hook rib 132 may be configured to be elastically deformable so that the hook of the gear mold 122 can be easily or flexibly inserted and fastened into the hook groove 132a formed in the hook rib 132 of the input-side rotor 130.

The press-fit ribs 133 may be disposed on both sides of the support rib formed in the gear mold 122 in a pair as a set, and be press-fitted and coupled to the side surface of the support rib of the support rib of the gear mold 122.

The press-fit rib 133 may protrude from one side of the input-side rotor 130 along the axial direction of the steering shaft 5 (in FIG. 3 of the exemplary embodiment, the press-fit rib 133 may be formed to extend upward) and may include a plurality of fastening protrusions 133a that protrudes along the circumferential direction and are press-fitted into the side surface of the support rib of the support rib of the gear mold 122.

The hook ribs 132 and the press-fit ribs 133 may be provided in multiple numbers along the circumferential direction of the input-side rotor 130 corresponding to the location, shape and configuration of the plurality of hooks and support ribs of the gear mold 122. In FIG. 3 of the exemplary embodiment, three hook ribs 132 are formed equiangularly along the circumferential direction of the input-side rotor 130, and the pair of press-fit ribs 133 is formed between two adjacent hook ribs 132.

The hook rib 132 and press-fit rib 133 may be formed integrally with the input-side rotor 130.

Meanwhile, the input-side rotor 130 is coupled to the input-side shaft 5a operably connected to the steering wheel 1 of the steering shaft 5, and the torque angle sensor 100 according to an embodiment of the present disclosure may further include the output-side rotor 140 positioned on a side opposite to the input-side rotor 130 with respect to the printed circuit board 160 and coupled to the output-side shaft 5b of the steering shaft 5.

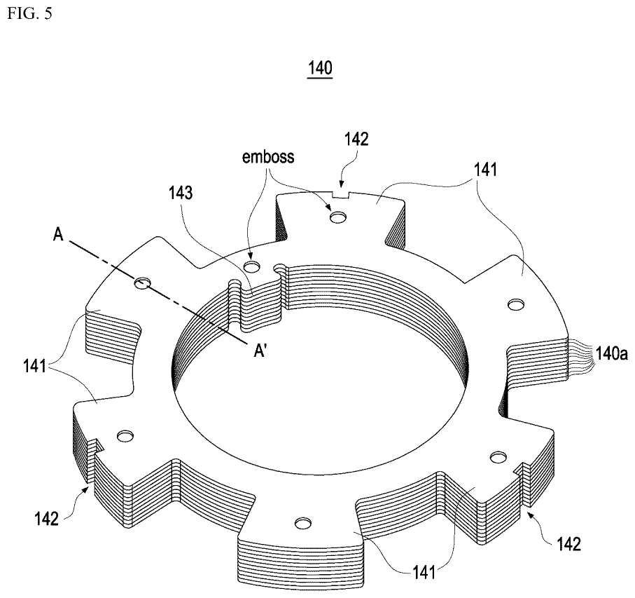

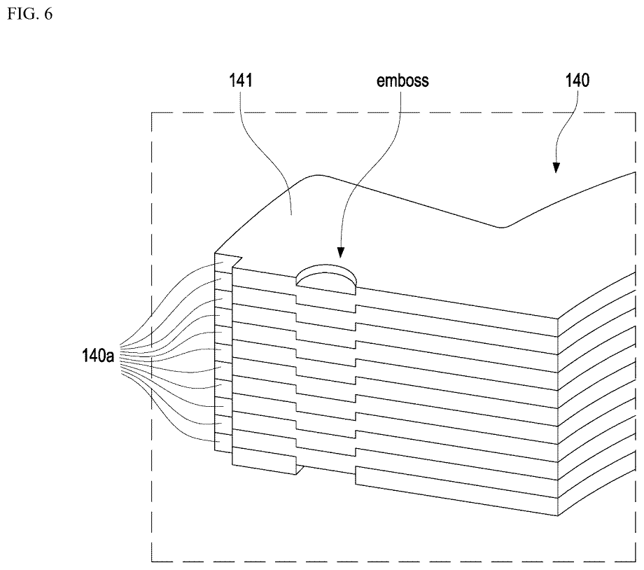

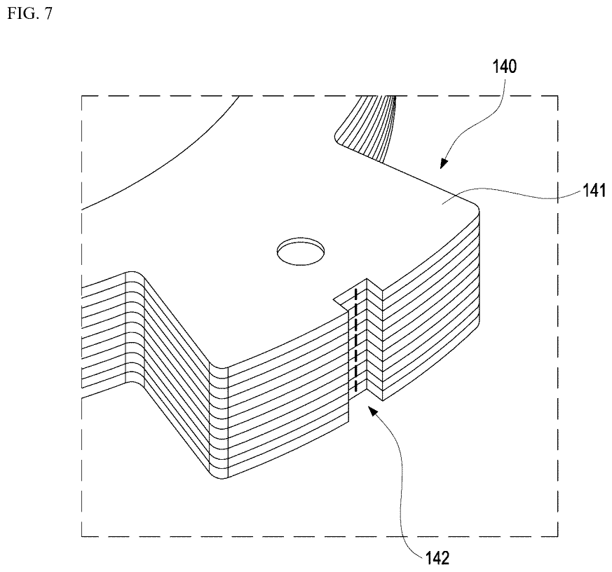

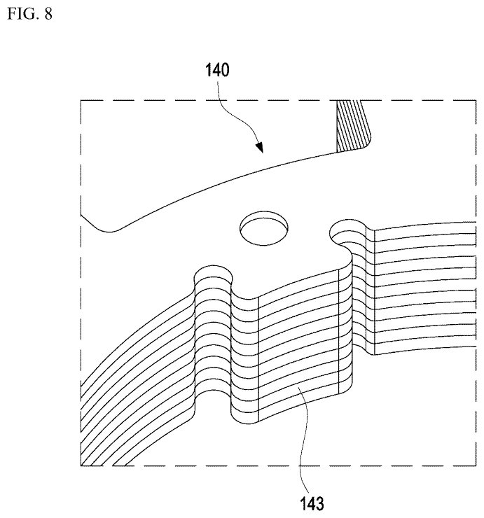

FIG. 4 is a view illustrating an output-side rotor of a conventional torque sensor. FIG. 5 is a view illustrating an output-side rotor of a torque angle sensor according to an embodiment of the present disclosure, and FIG. 6 is a cross-sectional view taken along a line A-A′ in FIG. 5. FIG. 7 is an enlarged view illustrating a portion of FIG. 5 where a second coupler is formed in an output-side rotor according to an embodiment of the present disclosure. FIG. 8 is an enlarged view illustrating another portion of FIG. 5 formed on an inner surface of an output-side rotor according to an embodiment of the present disclosure.

The output-side rotor 140 is disposed at a side opposite to the input-side rotor 130 with respect to the printed circuit board 160. The printed circuit board 160 is disposed between the input-side rotor 130 and the output-side rotor 140. And, the output-side rotor 140 may comprise a second coupler 141 made of a metal material and protruding in a wing shape and formed along the outer circumference of the output-side rotor 140 in a similar manner to the input-side rotor 130.

Referring to FIG. 4, the output-side rotor included in the conventional torque sensor may be provided in a similar form to the input-side rotor 130. The conventional output-side rotor is configured in a form of turning upside down the input-side rotor 130, except that the conventional output-side rotor does not include a fastening member or a fastener of an embodiment of the present disclosure for coupling the input-side rotor 130 with the gear mold 122. Such a conventional output-side rotor requires to be manufactured through complex processes such as machining and welding during manufacturing, and thus has a disadvantage in higher manufacturing cost and more complex manufacturing processes.

To resolve the disadvantages of the conventional structure as described above, certain embodiments of the present disclosure may change the processing method and material of the output-side rotor 140 coupled to the output-side shaft 5b of the steering shaft 5, thereby achieving the effects of simplifying the manufacturing process and reducing the cost.

Hereinafter, the structure of the output-side rotor 140 according to an exemplary embodiment of the present disclosure will be described in detail with reference to FIGS. 5 to 8.

The output-side rotor 140 according to an exemplary embodiment of the present disclosure may change the material and apply an optimized thickness to improve processability and prevent corrosion caused by the external environment.

Specifically, unlike conventional rotors that are manufactured using “SUS304”, a representative stainless-steel material, the output-side rotor 140 according to an exemplary embodiment of the present disclosure may be manufactured using a steel electro-galvanized cold commercial (SECC) material.

More specifically, the output-side rotor 140 may be manufactured by laminating a plurality of layers of thin plates 140a made of the SECC material. The plurality of plates 140a may be pressed through press processing to form the output-side rotor 140, and the thickness of each plate 140a forming each layer of the output-side rotor 140 may be, for example, but not limited to, 0.4 to 1.5 mm.

In addition, an exemplary embodiment of the present disclosure may have an embossing structure to prevent the plurality of lamination layers from being separated from each other when the output-side rotor 140 is press-fitted into the output-side shaft 5b of the steering shaft 5. Alternatively, another exemplary embodiment of the present disclosure may have a structure in which the outer side of the output-side rotor 140 is joined by laser welding or wrapped with a separate part or member. Hereinafter, the exemplary structures of the output-side rotor 140 for lamination separation prevention according to some embodiments of the present disclosure will be described in more detail.

First, with reference to FIGS. 5 and 6, an embodiment of the present disclosure may have an embossed structure to prevent separation of the laminations of the output-side rotor 140.

Each plate 140a of the output-side rotor 140 may be embossed in a circular shape, and the plates 140a that are stacked or laminated vertically may be coupled or arranged to each other through this embossed structure.

More specifically, a recessed portion having a circular cross-section may be formed on the upper surface of the plate 140a constituting the output-side rotor 140, and a protrusion having a circular cross-section may be formed on the lower surface of the plate 140a corresponding vertically to the recessed portion. In other words, a protrusion formed on one surface of one plate 140a is inserted into a recessed portion formed on the other surface of another plate 140a.

Moreover, when the plurality of plates 140a are stacked or laminated in the vertical direction, the protrusion formed on the lower surface of the plate 140a positioned on the upper side may be fitted into and coupled to the recessed portion formed on the upper surface of the plate 140a positioned on the lower side.

Accordingly, an embodiment of the present disclosure may prevent separation of the laminations of the manufactured output-side rotor 140 by increasing a coupling strength between plates 140a that are stacked or laminated in the vertical direction using an embossing structure.

The embossing structure as described above may be positioned approximately in or around the center of a portion where the second coupler 141 is formed in the output-side rotor 140 and in the vicinity where a key 143 described below is formed, and may be formed to have a diameter of at least 1 mm for increasing the strength for coupling the multiple laminations.

First, referring to FIGS. 5 and 7, an embodiment having a structure in which the outer side of the output-side rotor 140 is joined by laser welding or wrapped with a separate part or member to prevent separation of the laminates will be described.

The output-side rotor 140 according to an embodiment of the present disclosure may include a groove 142 formed in a vertical direction on the outer surface of a portion forming the second coupler 141.

At this time, laser welding may be performed along a line indicated by the dotted line in FIG. 7 within the groove 142 to provide coupling strength between plates 140a stacked or laminated in a plurality of layers.

Alternatively, a separate plate part or member may be inserted or installed along the groove 142 so that the plate part or member surrounds the plates 140a stacked or laminated in a plurality of layers, thereby providing or increasing the coupling strength for the plurality of layers. The plate part or member may be installed in a form that is inserted or fitted into the groove 142 and has a cross-section in the shape of the letter “⊏” or “U” to support the upper and lower ends of the output-side rotor 140.

The plurality of second couplers 141 is formed in the output-side rotor 140 according to an embodiment of the present disclosure. In this embodiment, the structure for preventing lamination separation by performing laser welding or installing a separate plate member as described above does not need to be applied to each of the second couplers 141, and sufficient coupling strength can be provided even when the laser welding or the separate plate ember is applied to only some of the plurality of second couplers 141.

In addition, in order to prevent the separation of the lamination of the output-side rotor 140, the embodiment using the laser welding and the embodiment using a separate plate part or member described above may be combined or applied together.

Meanwhile, the output-side rotor 140 according to an embodiment of the present disclosure may have a key structure for optimizing an inner diameter dimension for press-fitting the output-side rotor 140 into the output-side shaft 5b of the steering shaft 5 and for position alignment.

Referring to FIGS. 5 and 8, the output-side rotor 140 according to an embodiment of the present disclosure, which includes the laminate of the plurality of plates 140a, may include the key 143 formed inwardly protruding from the inner surface of the output-side rotor 140. The key 143 formed on the inner surface of the output-side rotor 140 may be engaged with a key groove formed on the output-side shaft 5b of the steering shaft 5.

The output-side rotor 140 according to an embodiment of the present disclosure is coupled to the output-side shaft 5b of the steering shaft 5 through the key structure, thereby eliminating the cogging process for fixing the position of the output-side shaft 5b.

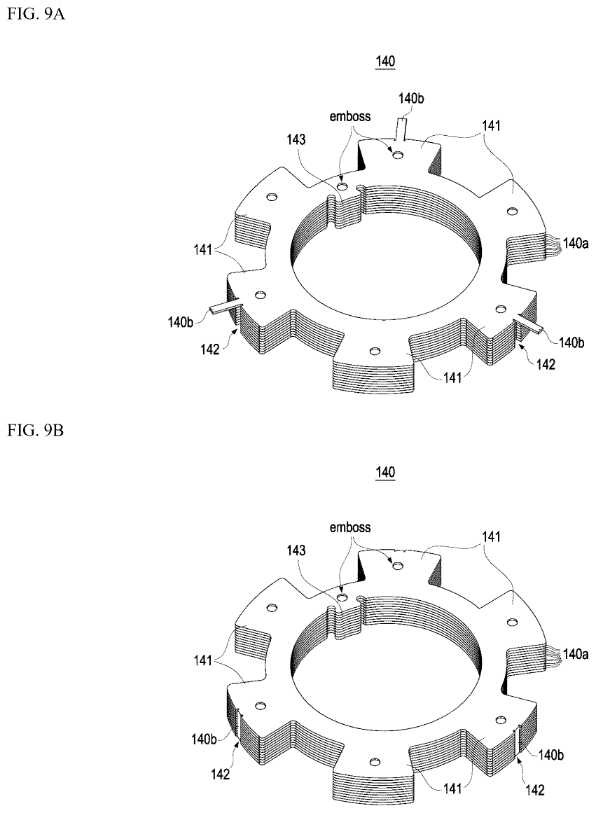

FIGS. 9A and 9B are perspective views illustrating an output-side rotor according to another embodiment of the present disclosure, FIG. 9A illustrates a perspective view of an output-side rotor before a separation prevention strap is bent, and FIG. 9B illustrates a perspective view of an output-side rotor after the separation prevention strap is bent.

Referring to FIG. 7, the separate plate part or member may be inserted or installed along the groove 142 formed on the outer surface of the output-side rotor 140 to increase or provide the coupling strength between the plates 140a laminated in the plurality of layers.

Another embodiment illustrated in FIGS. 9A and 9B is an embodiment for more easily implementing this, and one plate 140a positioned at the uppermost among the plurality of plates 140a may include a separation prevention strap 140b that is formed to protrude in an outward direction.

The separation prevention strap 140b formed on the uppermost plate 140a may be configured or provided to be bendable, and after the plurality of plates 140a is stacked or laminated in a plurality of layers, the separation prevention strap 140b, which is the protruding structure, is bent downward and press-fitted into the groove 142 of the other plates 140a located under the uppermost plate 140a, thereby effectively preventing the stacked or laminated structure of the output-side rotor 140 from being separated.

The separation prevention strap 140b may be formed at or on the second coupler 141 of the output-side rotor 140, and in this case, the separation prevention strap 140b and the corresponding groove 142 may be formed at or on all or some of the plurality of second couplers 141.

As illustrated in FIGS. 9A and 9B, three separation prevention straps 140b may be formed at positions forming a 120° angle with respect to each other, but the present embodiment is not limited thereto, and the separation prevention straps 140b may be provided in the number of two or more.

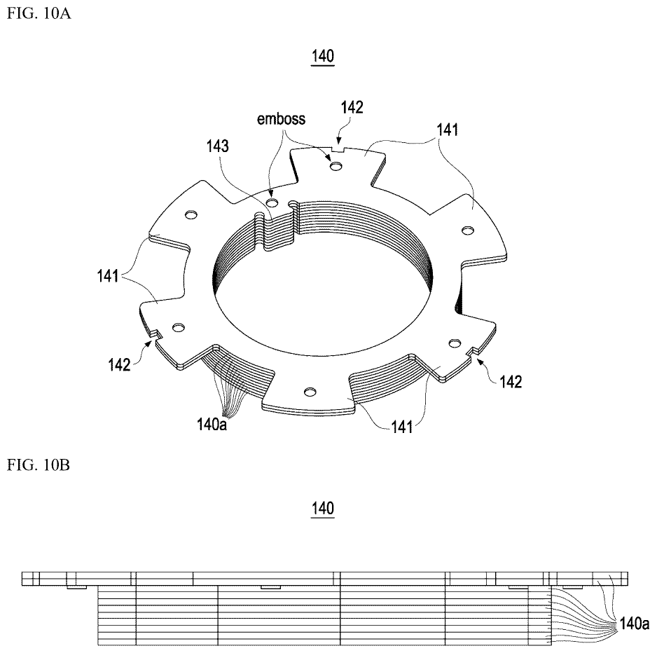

FIGS. 10A and 10B are perspective and side views illustrating an output-side rotor, respectively, according to another embodiment of the present disclosure.

FIGS. 10A and 10B illustrate an additional or alternative embodiment for weight minimization of the output-side rotor 140.

Referring to FIGS. 10A and 10B, among the plurality of plates 140a forming the output-side rotor 140, only some of the plates 140a positioned at the upper portion or side of the output-side rotor 140 (hereinafter “first type plates”) may include the second coupler 141, and the remains of the plates 140a (hereinafter “second type plates”) may have a simple circular ring shape without a coupler structure (e.g. an wing structure), thereby minimizing the weight of the output-side rotor 140.

In this case, the first type plates which are plates 140a positioned at the upper portion or side of the output-side rotor 140 among the plurality of plates 140a forming the plurality of layers, may include the second coupler 141, and the second coupler 141 may be optional for the second type plates 140a. In other words, the second type plates 140a which are located at the lower portion or side of the output-side rotor 140 may include or may not include the second coupler 141.

For example, to provide mechanical rigidity, the top plate 140a and one or two plates 140a immediately under the top plate 140a may include the second coupler 141.

As described above, according to the embodiment of the the present disclosure described above may have the effect of simplifying the manufacturing process and reducing the cost by changing the processing method and material of the output-side rotor 140.

The angle gear 150 may be provided as a substantially ring-shaped gear and may be rotatably accommodated in the gear groove 110b formed in the housing 110. The angle gear 150 is rotatably coupled with the gear mold 122 of the gear assembly 120 by meshing with the gear mold 122.

The angle gear 150 is a gear that includes a magnet for measuring the steering angle and is rotated by the gear mold 122 of the gear assembly 120.

The magnet included in the angle gear 150 may be used to obtain a rotation angle signal required for steering control. A Hall element such as a Hall sensor may be provided on the printed circuit board 160 to sense magnetic field generated by the magnet of the angle gear 150. The magnet may be attached or mounted to the angle gear 150.

The printed circuit board 160 may include an oscillating coil and a receiving or receiver coil that generate and receive magnetic flux to detect torque applied to the steering shaft 5, and a magnetic element that detects the amount of change in the magnetic flux. The magnetic element may be a magnetic sensor or a Hall sensor. For example, a pair of linear Hall elements (e.g. linear Hall IC) may be used as the magnetic element. The printed circuit board 160 may detect the angle of the rotors 130 and 140 to measure the torque applied to the steering shaft 5, and more specifically, may detect the magnetically induced current reflected from the rotors 130 and 140 to measure the torque.

In addition, the printed circuit board 160 may include a Hall element (e.g. Hall IC) that detects the magnetic field or the change in the magnetic field and rotation direction of a magnet that rotates together with the angle gear 150 to measure the rotation angle of the steering shaft 5 and a microcomputer (MYCOM) that receives a signal from the Hall element and calculates the rotation angle. The value calculated in the microcomputer may be transmitted to the electronic control unit 200 via a controller area network (CAN).

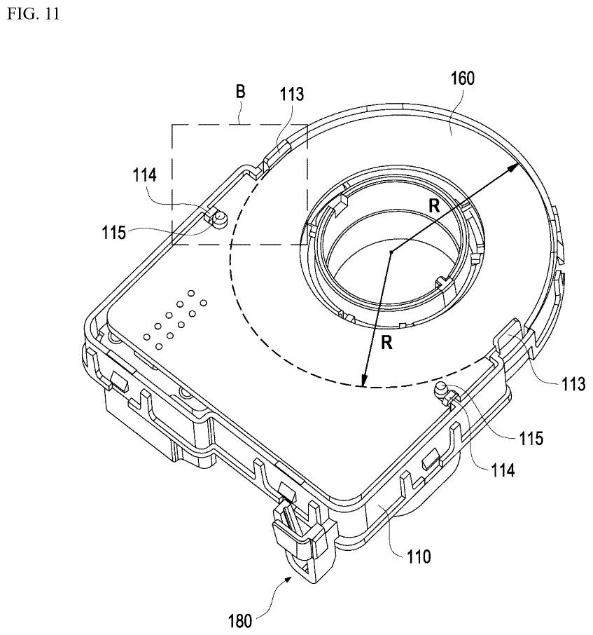

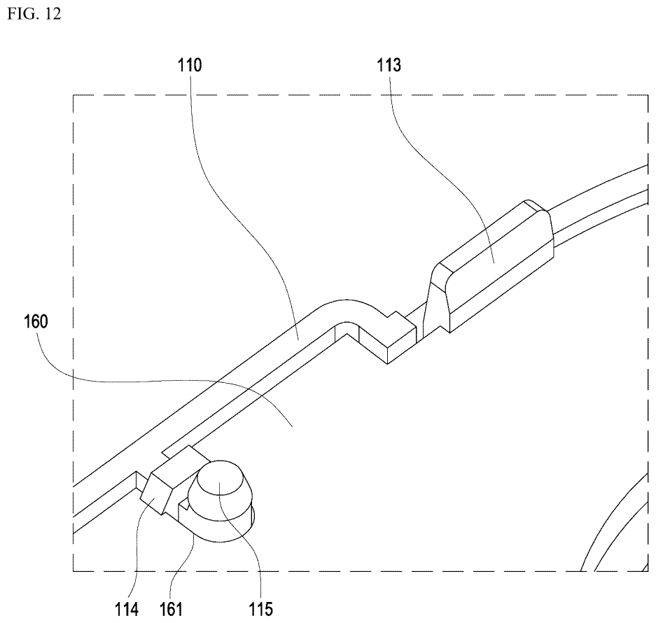

FIG. 11 is a view illustrating a state in which a printed circuit board is coupled to a housing of a torque angle sensor according to an embodiment of the present disclosure, and FIG. 12 is an enlarged view illustrating a portion indicated as “B” in FIG. 11. Note that FIGS. 11 and 12 illustrate a state in which the printed circuit board 160 is coupled to the lower side of the housing 110 in an upside-down manner.

The torque angle sensor 100 according to an embodiment of the present disclosure may include a hook fastening structure to secure the printed circuit board 160 to the housing 110.

Referring to FIGS. 11 and 12, the housing 110 may include a first hook member 113 that supports and fixes the edge of the printed circuit board 160. The first hook member 113 may be formed to protrude from an inner wall surface of the housing 110 and the plurality of the first hook members 113 may be formed to face the left and right sides of the housing 110.

The first hook member 113 may include an inclined surface to facilitate mounting when inserting the printed circuit board 160 into the housing 110 and a support surface that contacts and supports the edge of the printed circuit board 160 after the printed circuit board 160 is mounted to the housing 110.

In addition, the torque angle sensor 100 according to an embodiment of the present disclosure may include a guide structure when assembling or fastening the printed circuit board 160 to the housing 110.

For example, the housing 110 further includes a guide member 115 that protrudes from the inner bottom surface a direction opposite to a direction in which the printed circuit board 160 is inserted into the housing 110, and correspondingly, the printed circuit board 160 may include a guide groove 161 formed inwardly so that the guide member 115 can be inserted into the guide groove 161.

A portion where the guide member 115 of the housing 110 and the guide groove 161 of the printed circuit board 160 are formed may be located outside an imaginary circle with a radius (R) that is the distance from the center of the through hole 110a formed in the housing 110 to the end formed roundly in the printed circuit board 160 (e.g. the shortest length from the center of the the through hole 110a to the edge of the printed circuit board 160 closest to the center of the the through hole 110a).

In addition, the torque angle sensor 100 according to an embodiment of the present disclosure may further include a second hook member 114 formed adjacent to the guide member 115. The second hook member 114 may be formed to protrude from the inner bottom surface of the housing 110 together with the guide member 115.

The second hook member 114 may be coupled to and support a portion of the printed circuit board 160 where the guide groove 161 is formed, thereby preventing the printed circuit board 160 from being separated from the housing 110. Similar to the first hook member 113, the second hook member 114 may include an inclined surface to facilitate mounting when inserting the printed circuit board 160, and a support surface that contacts and supports the edge of the printed circuit board 160 after the printed circuit board 160 is mounted to the housing 110.

The torque angle sensor 100 according to an embodiment of the present disclosure may improve fixing strength between the printed circuit board 160 and the housing 110 as the printed circuit board 160 is fixed to the housing 110 in a hook-fastening manner, and furthermore, the structure protruding from the printed circuit board 160 can be eliminated, thereby enabling product miniaturization and reduction in manufacturing cost.

In the related art, a device is configured to fix the printed circuit board (PCB) to the housing using a press-fit structure called a “crush rib”, and thus a protrusion is formed that protruded outwardly from the printed circuit board PCB. However, the printed circuit board 160 according to an embodiment of the present disclosure may have a smooth shape without the protrusion structure that protrudes outwardly. Accordingly, it is possible to decrease the outer size of the printed circuit board 160, and reduce the overall package size of the torque angle sensor 100 and the electric power steering (EPS) including the torque angle sensor 110. In addition, it is possible to reduce the material cost of the printed circuit board 160 and improve the PCB array yield through this.

The torque angle sensor 100 may further include a connector 170 which is mounted on one side of the housing 110 and is configured to supply power and transmit signals.

Operations for detecting the torque and rotation angle of the steering shaft 5 using the torque angle sensor 100 according to an embodiments the present disclosure is described below.

When the driver turns the steering wheel 1 during steering operation, the input-side shaft 5a of the steering shaft 5 connected to the torsion bar rotates, and the rotation of the torsion bar causes the output-side shaft 5b connected to the torsion bar to be rotated. In addition, as the steering shaft 5 rotates, the gear assembly 120 coupled to the steering shaft 5, and the input-side rotor 130 and the output-side rotor 140 rotate together.

However, in this case, the output-side shaft 5b of the steering shaft 5 is connected to the wheel 2 in contact with the ground, so torque is generated in the torsion bar by the frictional resistance of the wheel 2, and accordingly, a difference occurs in a rotational amount of the input-side rotor 130 and the output-side rotor 140.

Due to this difference in rotational amount, a twist occurs between the input-side rotor 130 and the output-side rotor 140, and thus, a displacement occurs in the positions of the first coupler 131 included in or coupled to the input-side rotor 130 and the second coupler 141 included in or coupled to the output-side rotor 140. This causes a change in the magnetic flux of the magnetic field, which is detected by the printed circuit board 160 to obtain a torque signal required for steering control.

In addition, the rotation of the steering shaft 5 causes the angle gear 150, rotatably engaged with the gear mold 122 of the gear assembly 120, to be rotated. In this case, as the magnet included in or attached to the angle gear 150 rotates together with the angle gear 150, the change in the magnetic field may be detected by the Hall element provided on the printed circuit board 160 to obtain the rotation angle signal.

The printed circuit board 160 may transmit the acquired torque signal and rotation angle signal to the electronic control unit 200, and the electronic control unit 200 may determine the auxiliary operating force required for steering the vehicle based on the received torque signal and rotation angle signal to drive the motor 300, or the like.

The torque angle sensor 100 according to the present disclosure is mounted on a steering shaft 5 and accommodated in a main housing of the electric power steering (EPS). Here, the main housing is a separate component from the housing 110 forming the body of the torque angle sensor 100, and is another case component that accommodates the entire torque angle sensor 100 including the housing 110. Alternatively, the housing 110 of the torque angle sensor 100 may be integrally formed with the main housing of the EPS.

The main housing of the EPS may be fixedly installed on the vehicle body. The main housing has a hole formed in the center to allow the steering shaft 5 to pass through, and the torque angle sensor 100 is installed and accommodated in the internal space.

However, the torque angle sensor 100 rotates left and right at a predetermined angle in accordance with the rotation of the steering shaft 5, and therefore, the torque angle sensor 100 should have durability for millions of cycles of rotation.

To this end, the torque angle sensor 100 according to an embodiment of the present disclosure is provided with an anti-rotation structure to prevent rotation within the main housing of the EPS, and the anti-rotation structure provided in the torque angle sensor 100 according to an embodiment of the present disclosure will be described below.

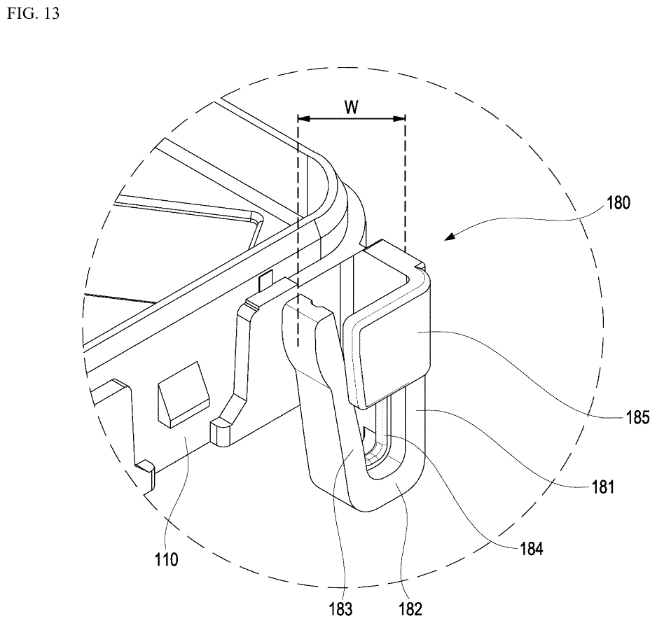

FIG. 13 is a view illustrating an anti-rotation structure provided in a housing of a torque angle sensor according to an embodiment of the present disclosure. Referring to FIG. 13, the torque angle sensor 100 according to an embodiment of the present disclosure may further include a spring member 180 provided outside the housing 110.

The spring member 180 may be inserted into and coupled to a slot formed in a groove shape on the inner surface of the main housing of the EPS. The spring member 180 prevents the torque angle sensor 100 from rotating within the main housing of the EPS, absorbs shock caused by a change in the rotational direction of the steering shaft 5, and ensures the radial and axial positions of the steering shaft 5.

The spring member 180 may include a support portion 181, a connecting portion 182, and an elastic arm 183. The support portion 181 may be connected to one side of the housing 110 and formed in a substantially vertical direction. The connecting portion 182 is bent from the lower end of the support portion 181 and formed in a substantially horizontal direction. The elastic arm 183 extends upward again from the connecting portion 182.

The support portion 181, the connecting portion 182, and the elastic arm 183 may be provided as an integral structure, and it may be understood that the connecting portion 182 and the elastic arm 183 are formed to extend from the support portion 181. However, while the support portion 181 is connected to one side of the housing 110, the connecting portion 182 and the elastic arm 183 are not directly connected to the housing 110.

The elastic arm 183 is formed at a distance from the support portion 181 in a direction along the outer wall surface of the housing 110 in which the spring member 180 is installed, and thus a void space is formed between the support portion 181 and the elastic arm 183.

The elastic arm 183 may be formed to be inclined at a predetermined angle and has an elastic configuration so that the elastic arm can be deformed in a width direction of the slot when mounted in the slot of the main housing of the EPS.

According to operations of the anti-rotation structure according to an embodiment of the present disclosure, when the torque angle sensor 100 is rotated at a predetermined angle together with the steering shaft 5 within the main housing of the EPS, the elastic arm 183 of the spring member 181 inserted within the slot of the main housing of the EPS comes into contact with the side wall of the slot, and a restoring force is generated by the elasticity of the elastic arm 183, so that the torque angle sensor 100 can return to its original position.

Meanwhile, a spring device equipped in a conventional torque sensor includes a metal spring made of metal material. In contrast, some embodiments of the present disclosure may not need a metal spring made of metal material and the anti-rotation structure of the torque angle sensor 100 may be configured using a single plastic material, thereby simplifying the structure of the device and the component assembly process.

In order to implement the anti-rotation structure using the single plastic material according to an embodiment of the present disclosure, design reinforcement is required due to the absence of the metal spring. Accordingly, the spring member 180 having a single plastic material may be required as the anti-rotation structure of the torque angle sensor 100 according to an embodiment of the present disclosure.

An embodiment of the present disclosure may include a rib structure to reinforce the elasticity and rigidity of the spring member 180. Specifically, the spring member 180 may further include a reinforcing rib 184 formed on the inner surface of the spring member 180.

The reinforcing rib 184 may be formed to extend along the inner surface of the spring member 180 including the support portion 181, the connecting portion 182, and the elastic arm 183, and may be formed in a shape of protruding from the inner surface and has a predetermined thickness and height.

The reinforcing rib 184 may be provided as a separate part or piece and attached to the inner surface of the spring member 180, but may be formed integrally by injection molding together with the support portion 181, the connecting portion 182, and the elastic arm 183.

Alternatively or additionally, the reinforcing rib 184 may be formed on the outer surface rather than the inner surface of the spring member 180, or may be formed on both the inner and outer surfaces of the spring member 180.

In addition, an embodiment of the present disclosure may comprise a stopper structure so that the performance of the torque angle sensor 100 can be maintained even when the elastic arm 183 of the spring member 180 is damaged. For example, the spring member 180 may further include a stopper 185 that is formed to extend from the side end of the support portion 181 in a direction toward the elastic arm 183.

The stopper 185 may be provided as a substantially plate-shaped member having a substantially square shape with a predetermined area, and when the elastic arm 183 is damaged, the stopper 185 may come into contact with the side wall of the slot instead of the elastic arm 183 so as to maintain the performance of the torque angle sensor 100. The stopper 185 may be formed in a direction parallel to the outer wall surface of the housing 110 in which the spring member 180 is installed, and may be disposed in a form that partially covers the space formed between the support portion 181 and the elastic arm 183.

Likewise, the stopper 185 may be integrally formed by injection molding together with the support portion 181, the connecting portion 182, and the elastic arm 183. That is, the spring member 180 may be integrally formed by injection molding to form the support portion 181, the connecting portion 182, the elastic arm 183, the reinforcing rib 184, and the stopper 185 as in a single piece.

Additionally, the spring member 180 may be formed integrally when the housing 110 that constitutes the body of the torque angle sensor 100 is molded, or may be manufactured as a separate part and fixed to the outside of the housing 110.

Meanwhile, the spring member 180 according to an embodiment of the present disclosure may be dimensionally optimized to maintain the reaction force and elastic force, and specifically, the thickness of the elastic arm 183 may be designed to be within 1.8 mm for appropriately maintaining the reaction force and elastic force.

In addition, the spring member 180 according to an embodiment of the present disclosure may have a dimension of an optimized ratio so as to maintain minimum elasticity when the spring member 180 is mounted in the slot of the main housing of the EPS. For instance, the maximum width W of the spring member 180 can be designed to be at least 10% to at most 20% larger than the width of the slot formed in the main housing of the EPS. Here, the maximum width W of the spring member 180 means the widest width in a direction along the outer wall surface of the housing 110 in which the spring member 180 is installed, and may mean the distance between the upper outer portion of the support portion 181 and the upper outer portion of the elastic arm 183.

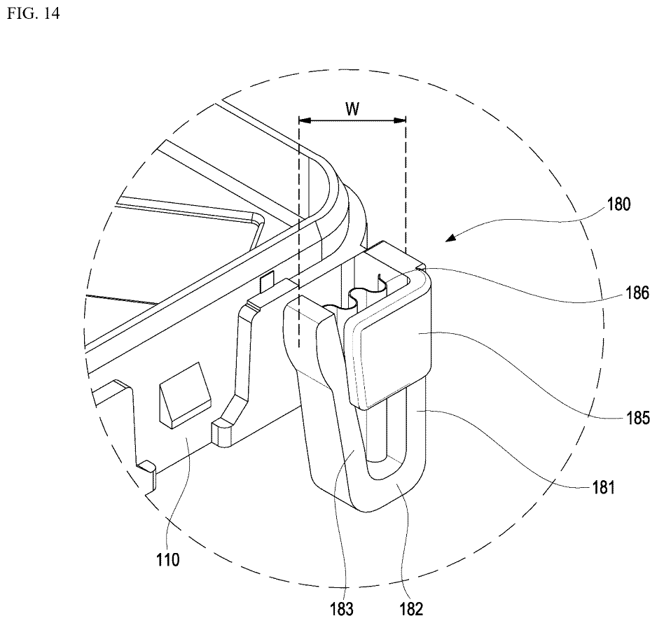

FIG. 14 is a perspective view illustrating an anti-rotation structure according to another embodiment of the present disclosure. The embodiment illustrated in FIG. 14 has a reinforcing plate 186 instead of the reinforcing rib 184 to reinforce the elasticity and rigidity of the spring member 180, and the other configuration is the same as or similar to the embodiment of FIG. 13.

Specifically, the reinforcing plate 186 may be a thin plate having a waveform cross-section and may be configured to extend from the inner wall of the support portion 181 to the inner wall of the elastic arm 183.

That is, the reinforcing plate 186 is configured to interconnect the support portion 181 and the elastic arm 183, and the overall elasticity and rigidity of the spring member 180 may be reinforced by the wave-shaped structure of the reinforcing plate 186.

The reinforcing plate 186 may be integrally formed by injection molding together with the support portion 181, the connecting portion 182, and the elastic arm 183.

According to some embodiments of the present disclosure as described above, the anti-rotation structure of the torque angle sensor 100 installed inside the main housing of the EPS may not include an existing metal spring and instead may comprise a single plastic material, thereby simplifying the structure and assembly process, resulting in cost reduction, and increasing the robustness of the anti-rotation structure.

What is claimed is:

1. A torque angle sensor comprising:
a housing having a through hole through which a shaft passes;
a gear assembly disposed in the housing and fixed to the shaft to be rotatable together with the shaft;
a rotor disposed in the housing and coupled to the gear assembly to be rotatable together with the gear assembly;
a printed circuit board mounted to the housing and configured to detect rotation of the rotor and torque applied to the shaft; and
a spring member positioned outside the housing and in a slot formed on an inner surface of a main housing in which the housing is accommodated,
wherein the spring member includes:
a support portion connected to one side of the housing,
an elastic arm facing the support portion and configured to be deformable in a direction toward or away from the support portion, and
a connecting portion bent to connect the support portion and the elastic arm.

2. The torque angle sensor according to claim 1, wherein the spring member has plastic material.

3. The torque angle sensor according to claim 2, wherein the support portion, the connecting portion, and the elastic arm are integrally formed in a single piece.

4. The torque angle sensor according to claim 3, wherein the spring member integrally formed with the housing in a single piece.

5. The torque angle sensor according to claim 2, wherein the connecting portion and the elastic arm are connected to the housing via the support portion.

6. The torque angle sensor according to claim 5, wherein the elastic arm is spaced apart from the support portion in a direction along an outer wall surface of the housing from which the spring member is extended.

7. The torque angle sensor according to claim 6, wherein the elastic arm is inclined with respect to the support portion.

8. The torque angle sensor according to claim 7, wherein the elastic arm has a thickness of less than 1.8 mm.

9. The torque angle sensor according to claim 7, wherein a maximum width the spring member is 10 to 20% larger than a width of the slot.

10. The torque angle sensor according to claim 7, wherein the spring member further includes a reinforcing rib formed on at least one of inner and/or outer surfaces of the spring member.

11. The torque angle sensor according to claim 10, wherein the reinforcing rib protrudes from at least a part of a surface of the support portion, a surface of the connecting portion, and at least a part of a surface of the elastic arm.

12. The torque angle sensor according to claim 10, wherein the spring member further includes a stopper extending from the support portion in a direction toward the elastic arm and configured to contact the slot instead of the elastic arm when the elastic arm is damaged.

13. The torque angle sensor according to claim 12, wherein the stopper is substantially plate-shaped and arranged substantially parallel to the outer wall surface of the housing from which the spring member is extended from.

14. The torque angle sensor according to claim 12, wherein the reinforcing rib and the stopper are formed integrally with the spring member.

15. The torque angle sensor according to claim 13, wherein the spring member is integrally formed with the housing.

16. The torque angle sensor according to claim 7, wherein the spring member further includes a wave-shaped plate connecting an inner surface of the support portion and an inner surface of the elastic arm.

17. An electric power steering comprising:
a torque angle sensor including a housing having a through hole through which a shaft passes, a gear assembly disposed in the housing and fixed to the shaft to be rotatable together with the shaft, a rotor disposed in the housing and coupled to the gear assembly to be rotatable together with the gear assembly, a printed circuit board mounted to the housing and configured to detect rotation of the rotor and torque applied to the shaft, and a spring member positioned outside the housing; and
a main housing in which the torque angle sensor is accommodated,
wherein the spring member is coupled to a slot formed on an inner surface of the main housing, and
wherein the spring member includes:
a support portion connected to one side of the housing,
an elastic arm facing the support portion and configured to be deformable in a direction toward or away from the support portion, and
a connecting portion bent to connect the support portion and the elastic arm.

18. The electric power steering according to claim 17, wherein the spring member further includes a reinforcing rib formed on at least one of inner and/or outer surfaces of the spring member.

19. The electric power steering according to claim 18, wherein the spring member further includes a stopper extending from the support portion in a direction toward the elastic arm and configured to contact the slot instead of the elastic arm when the elastic arm is damaged.

20. The electric power steering according to claim 19, wherein the spring member has plastic material and is formed integrally with the housing.
